(19) United States
(12) Patent Application Publication
(10) Pub. No.: US 2026/0192633 A1
(43) Pub. Date: Jul. 9, 2026

(54) TEMPERATURE ADJUSTMENT CIRCUIT

(71) Applicant: HONDA MOTOR CO., LTD., Tokyo (JP)

(72) Inventors: Satoki UEMATSU, Tokyo (JP); Takuro KOTO, Tokyo (JP); Naoya YOKOTA, Tokyo (JP)

(73) Assignee: HONDA MOTOR CO., LTD., Tokyo (JP)

(21) Appl. No.: 19/439,505

(22) Filed: Jan. 5, 2026

(30) Foreign Application Priority Data
Jan. 8, 2025 (JP) 2025-002726

(51) Int. Cl. B60H 1/32

(52) U.S. Cl. CPC B60H 1/32284

(57) ABSTRACT

A temperature adjustment circuit has a refrigeration cycle and a heat exchange circuit. The refrigeration cycle includes a first compressor configured to compress and discharge a first refrigerant, a first heat exchanger configured to perform a heat exchange with the first refrigerant compressed by the first compressor, a first expansion valve configured to decompress the first refrigerant that has passed through the first heat exchanger, and a second heat exchanger configured to perform a heat exchange with the first refrigerant that has passed through the first expansion valve. The heat exchange circuit is configured to connect the first heat exchanger, the second heat exchanger, and a temperature adjustment target to allow a heat exchange via the second refrigerant. In the heat exchange circuit, the first heat exchanger, the second heat exchanger, and the temperature adjustment target are, in this order, disposed in a flow direction of the second refrigerant.

### CROSS-REFERENCE TO RELATED APPLICATIONS

This application is based on and claims priority under 35 USC 119 from Japanese Patent Application No. 2025-002726 filed on January 8, 2025, the entire content of which is incorporated herein by reference.

### TECHNICAL FIELD

The present disclosure relates to a temperature adjustment circuit.

### BACKGROUND ART

In recent years, efforts to realize a low-carbon society or a decarbonized society become active, and it is required to reduce CO₂ emission and improve energy efficiency also in moving objects such as automobiles.

JP2002-098429A below discloses a technique in which in a hot water supply system including a heat pump and a hot water storage tank, a heat exchanger and a subsidiary heat exchanger are provided in a refrigerant circuit of the heat pump, and the subsidiary heat exchanger is disposed upstream of the heat exchanger in a flow passage for allowing water to circulate between the heat pump and the hot water storage tank.

However, in the technique disclosed in JP2002-098429A, since the subsidiary heat exchanger is disposed downstream of the hot water storage tank, a refrigerant circulating in the refrigerant circuit cannot receive sufficient heat via the subsidiary heat exchanger, and it is required to improve it from the viewpoint of quickly increasing a temperature of the refrigerant.

### SUMMARY OF INVENTION

The present disclosure provides a temperature adjustment circuit capable of quickly increasing a temperature of a first refrigerant circulating in a refrigeration cycle.

An aspect of the present disclosure is a temperature adjustment circuit having:

a refrigeration cycle including:

a first compressor configured to compress and discharge a first refrigerant;

a first heat exchanger configured to perform a heat exchange with the first refrigerant compressed by the first compressor;

a first expansion valve configured to decompress the first refrigerant that has passed through the first heat exchanger; and

a second heat exchanger configured to perform a heat exchange with the first refrigerant that has passed through the first expansion valve; and

a heat exchange circuit configured to connect the first heat exchanger, the second heat exchanger, and a first temperature adjustment target to allow a heat exchange via the second refrigerant, in which

in the heat exchange circuit, the first heat exchanger, the second heat exchanger, and the first temperature adjustment target are, in this order, disposed in a flow direction of the second refrigerant.

According to the aspect of the present disclosure, it is possible to provide the temperature adjustment circuit capable of quickly increasing a temperature of the first refrigerant circulating in the refrigeration cycle. The aspect of the present disclosure further contributes to improvement of energy efficiency of a moving object.

### BRIEF DESCRIPTION OF DRAWINGS

Exemplary embodiment(s) of the present invention will be described in detail based on the following figures, wherein:

FIG. 1 is a schematic configuration diagram of a vehicle V; and

FIG. 2 illustrates an example of a temperature adjustment circuit 10 mounted on the vehicle V.

### DESCRIPTION OF EMBODIMENTS

Hereinafter, an embodiment according to the present disclosure will be described in detail below with reference to the drawings. The drawings are viewed in directions of reference numerals. Not all the elements to be described in the following embodiments are necessarily essential for the present invention. Hereinafter, the same or similar elements are denoted by the same or similar reference numerals, and the description thereof may be omitted or simplified as appropriate.

### Vehicle

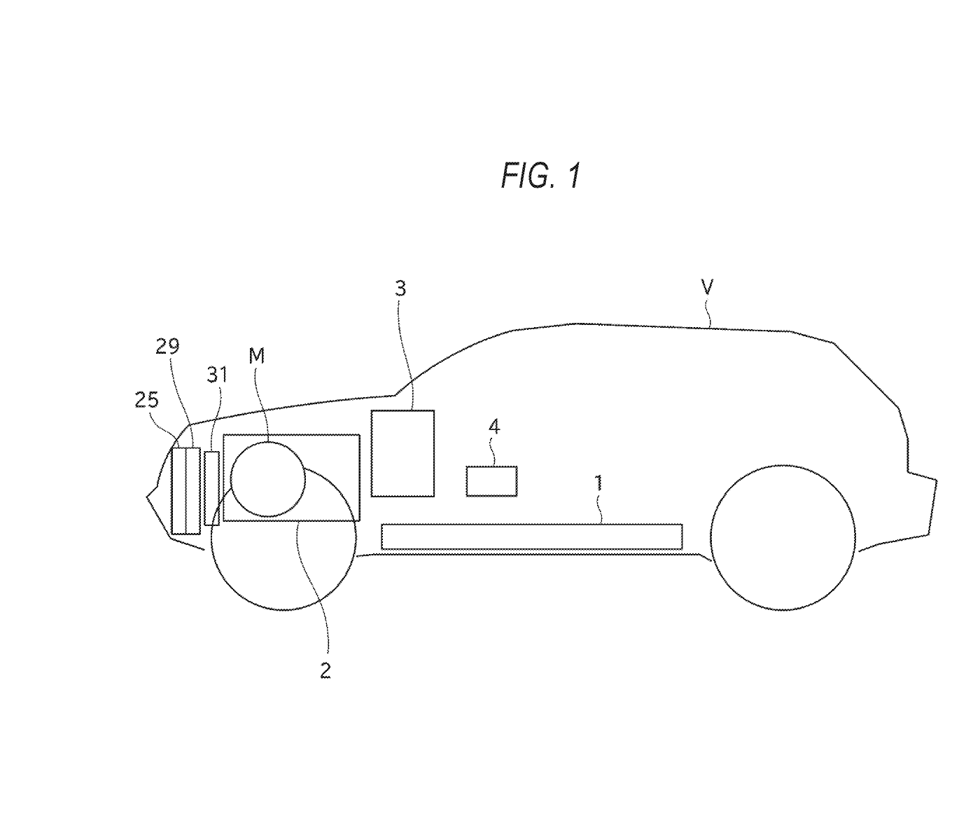

As illustrated in FIG. 1, a vehicle V, which is an example of a moving object, is an electric vehicle including a battery 1, a drive unit (DU) 2 that drives the vehicle Vto travel by power supplied from the battery 1, a heating ventilation and air-conditioning (HVAC) 3 that controls air conditioning in a passenger compartment of the vehicle V, and a control device (ECU: Electronic Control Unit) 4.

The drive unit 2 includes, for example, a motor M as a motor (so-called traction motor) that drives drive wheels of the vehicle V. The motor M is, for example, a three-phase AC motor, and may generate heat by operating. That is, the drive unit 2 may include a heat generation source.

The drive unit 2 may include an inverter or a DC-DC converter (DC: Direct Current) as a power conversion device that converts power exchanged between the battery 1 and the motor M, a charger that charges the battery 1 using power received from an external power supply, and the like. As another example, the inverter, the DC-DC converter, or the charger may be provided in the vehicle V in combination with the battery 1 as one unit. In this case, the "battery 1" in the following description may be replaced with a unit in which at least one of the inverter, the DC-DC converter, and the charger is combined with the battery 1.

The HVAC 3 is a system capable of cooling and heating the passenger compartment of the vehicle V, and includes, for example, a refrigeration cycle 11 to be described later. In addition, in the front of the vehicle V (for example, in an engine room provided in a front portion of the vehicle V), a third heat exchanger 25 (for example, a condenser) of the refrigeration cycle 11 and a fifth heat exchanger 29 (for example, a radiator) of the heat exchange circuit 12 to be described later are provided, and an electric fan 31 that promotes heat dissipation and/or heat absorption thereof is also provided.

The control device 4 is a computer for integrally controlling the entire vehicle V, and is implemented by an electronic control unit (ECU) including, for example, a processor that performs various types of calculation, a memory that stores various types of information, and an interface (I/F) that controls input and output of data between inside and outside of the control device 4. As an example, the control device 4 controls a temperature adjustment circuit 10 to be described later to realize temperature adjustment of the battery 1 and/or the drive unit 2 and realize cooling and heating of the passenger compartment.

### Temperature Adjustment Circuit

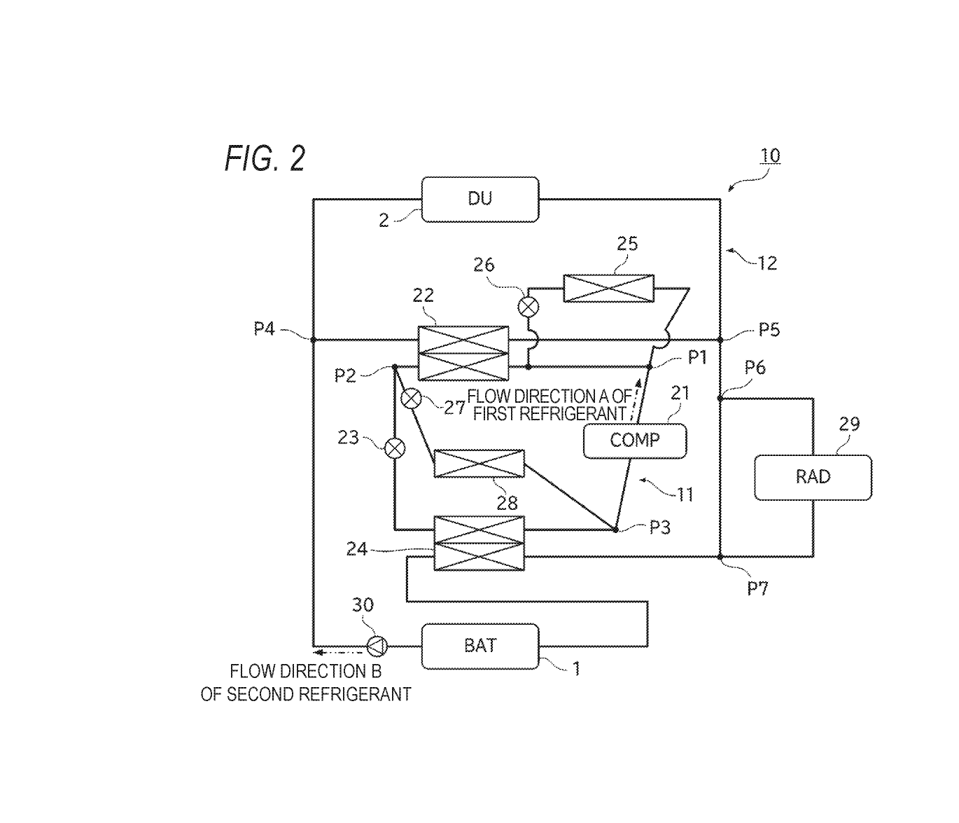

The vehicle V is equipped with the temperature adjustment circuit 10 illustrated in FIG. 2. The temperature adjustment circuit 10 is a temperature adjustment circuit capable of adjusting a temperature of the battery 1 as the first temperature adjustment target. In the present embodiment, the temperature adjustment circuit 10 includes a refrigeration cycle 11 and a heat exchange circuit 12.

The refrigeration cycle 11 is a refrigeration cycle that allows a first refrigerant to circulate therethrough, and realizes cooling and heating of the passenger compartment under the control of the control device 4, for example. The refrigeration cycle 11 includes, for example, a first compressor 21, a first heat exchanger 22, a first expansion valve 23, a second heat exchanger 24, a third heat exchanger 25, a second expansion valve 26, a third expansion valve 27, and a fourth heat exchanger 28. The first refrigerant is, for example, an air conditioner refrigerant such as HFC-134a or HFO-1234yf. In FIG. 2, a flow direction A of the first refrigerant in the refrigeration cycle 11 is indicated by a dashed-dotted arrow.

The first compressor 21 is configured by, for example, an electric compressor, and compresses and discharges the first refrigerant. The first heat exchanger 22 is configured by, for example, a liquid cooled condenser (LCC), and performs a heat exchange between the first refrigerant compressed by the first compressor 21 and a second refrigerant (to be described later) flowing through the heat exchange circuit 12. That is, the first heat exchanger 22 can perform the heat exchange with the first refrigerant compressed by the first compressor 21. As an example, according to the first heat exchanger 22, the heat of the first refrigerant can be transferred to the second refrigerant.

The first expansion valve 23 is configured by, for example, electronic expansion valves (EXV), and decompresses the first refrigerant that has passed through the first heat exchanger 22. The second heat exchanger 24 is configured by, for example, a chiller, and performs a heat exchange between the first refrigerant that has passed through the first expansion valve 23 (in other words, the first refrigerant decompressed by the first expansion valve 23) and the second refrigerant flowing through the heat exchange circuit 12. That is, the second heat exchanger 24 can perform the heat exchange with the first refrigerant that has passed through the first expansion valve 23. As an example, according to the second heat exchanger 24, the heat of the second refrigerant can be transferred to the first refrigerant.

The third heat exchanger 25 is configured by, for example, a cabin condenser, and heats the passenger compartment by performing a heat exchange with the first refrigerant compressed by the first compressor 21 (that is, the first refrigerant flowing through the refrigeration cycle 11). That is, the third heat exchanger 25 can perform the heat exchange with the first refrigerant compressed by the first compressor 21.

As illustrated in FIG. 2, the third heat exchanger 25 is disposed upstream of the first heat exchanger 22 in the flow direction A of the first refrigerant in the refrigeration cycle 11. In other words, the third heat exchanger 25 is disposed upstream of the first heat exchanger 22 when viewed from a discharge portion of the first compressor 21 that discharges the compressed first refrigerant.

More specifically, in the refrigeration cycle 11, a branch point P1 is provided between the first compressor 21 and the third heat exchanger 25 to split the flow of the first refrigerant from the first compressor 21 into the first heat exchanger 22 side and the third heat exchanger 25 side. The branch point P1 is provided with a flow rate adjustment valve capable of adjusting a flow rate of the first refrigerant to the third heat exchanger 25. The flow rate adjustment valve provided at the branch point P1 adjusts the flow rate of the first refrigerant to the third heat exchanger 25, for example, under the control of the control device 4. When the flow rate of the first refrigerant to the third heat exchanger 25 is greater than 0 (zero), the first refrigerant compressed by the first compressor 21 is supplied to the third heat exchanger 25. The flow rate adjustment valve provided at the branch point P1 may also set the flow rate of the first refrigerant to the third heat exchanger 25 to 0.

In the refrigeration cycle 11, a circuit directed to the first heat exchanger 22 from the branch point P1 in FIG. 2 without passing through the third heat exchanger 25 and the second expansion valve 26 may not be provided. In this case, all of the first refrigerant discharged by the first compressor 21 is supplied to the first heat exchanger 22 after passing through the third heat exchanger 25 and the second expansion valve 26.

The second expansion valve 26 is configured by, for example, EXV, is disposed between the first heat exchanger 22 and the third heat exchanger 25, and decompresses the first refrigerant that has passed through the third heat exchanger 25. The first refrigerant that has passed through the second expansion valve 26 (in other words, the first refrigerant decompressed by the second expansion valve 26) flows to the first heat exchanger 22.

The third expansion valve 27 is configured by, for example, EXV, and decompresses the first refrigerant that has passed through the first heat exchanger 22. More specifically, in the refrigeration cycle 11, a branch point P2 is provided between the first heat exchanger 22 and the third expansion valve 27 to split the flow of the first refrigerant from the first heat exchanger 22 into the first expansion valve 23 and second heat exchanger 24 side and the third expansion valve 27 and fourth heat exchanger 28 side. The branch point P2 is provided with a flow rate adjustment valve capable of adjusting the flow rate of the first refrigerant to the third expansion valve 27 and fourth heat exchanger 28 side. The flow rate adjustment valve provided at the branch point P2 adjusts the flow rate of the first refrigerant to the third expansion valve 27 and fourth heat exchanger 28 side, for example, under the control of the control device 4. When the flow rate of the first refrigerant to the third expansion valve 27 and fourth heat exchanger 28 side is greater than 0, the first refrigerant that has passed through the first heat exchanger 22 is decompressed by the third expansion valve 27 and then flows to the fourth heat exchanger 28. The flow rate adjustment valve provided at the branch point P2 may also set the flow rate of the first refrigerant to the third expansion valve 27 and fourth heat exchanger 28 side to 0.

The fourth heat exchanger 28 is configured by, for example, an evaporator, and cools the passenger compartment by performing a heat exchange with the first refrigerant that has passed through the third expansion valve 27. That is, the fourth heat exchanger 28 can perform the heat exchange with the first refrigerant that has passed through the third expansion valve 27.

As illustrated in FIG. 2, the third expansion valve 27 and the fourth heat exchanger 28 are disposed downstream of the first heat exchanger 22 in the flow direction A of the first refrigerant in the refrigeration cycle 11. In other words, the third expansion valve 27 and the fourth heat exchanger 28 are disposed downstream of the first heat exchanger 22 when viewed from the discharge portion of the first compressor 21 that discharges the compressed first refrigerant.

In the refrigeration cycle 11, a junction P3 where the flow of the first refrigerant from the second heat exchanger 24 and the flow of the first refrigerant from the fourth heat exchanger 28 are joined is provided between the fourth heat exchanger 28 and the first compressor 21, and the first refrigerant returns to the first compressor 21 through the junction P3.

The heat exchange circuit 12 connects the first heat exchanger 22, the second heat exchanger 24, and the battery 1 (that is, the first temperature adjustment target) to allow a heat exchange via the second refrigerant. As described above, each of the first heat exchanger 22 and the second heat exchanger 24 can perform the heat exchange between the first refrigerant flowing through the refrigeration cycle 11 and the second refrigerant flowing through the heat exchange circuit 12. The second refrigerant is, for example, a long life coolant (LLC).

In FIG. 2, a flow direction B of the second refrigerant in the heat exchange circuit 12 is indicated by a dashed double-dotted arrow. The second refrigerant in the heat exchange circuit 12 flows in the flow direction B indicated by the dashed double-dotted arrow in FIG. 2 by being pumped by a pump 30 provided in the heat exchange circuit 12. As illustrated in FIG. 2, the first heat exchanger 22, the second heat exchanger 24, and the battery 1 are disposed in this order in the flow direction B of the second refrigerant.

Further, the heat exchange circuit 12 connects the drive unit (DU) 2 as the second temperature adjustment target different from the battery 1 to allow the heat exchange via the second refrigerant. As illustrated in FIG. 2, the drive unit 2 is disposed downstream of the battery 1 as the first temperature adjustment target and upstream of the second heat exchanger 24 in the flow direction B of the second refrigerant. The first heat exchanger 22 and the drive unit 2 are disposed in parallel between the battery 1 and the second heat exchanger 24.

More specifically, in the heat exchange circuit 12, a branch point P4 is provided between the battery 1 and the drive unit 2 to split the flow of the second refrigerant from the battery 1 into the first heat exchanger 22 side and the drive unit 2 side. The branch point P4 is provided with a flow rate adjustment valve capable of adjusting a flow rate of the second refrigerant to the drive unit 2 side. The flow rate adjustment valve provided at the branch point P4 adjusts the flow rate of the second refrigerant to the drive unit 2 side, for example, under the control of the control device 4. When the flow rate of the second refrigerant to the drive unit 2 side is greater than 0, the second refrigerant flows to the drive unit 2, and the temperature of the drive unit 2 is adjusted (for example, cooled). The flow rate adjustment valve provided at the branch point P4 may also set the flow rate of the second refrigerant to the drive unit 2 side to 0.

In the heat exchange circuit 12, a junction P5 where the flow of the second refrigerant from the first heat exchanger 22 and the flow of the second refrigerant from the drive unit 2 are joined is provided downstream of the first heat exchanger 22, and the second refrigerant flows to the second heat exchanger 24 side through the junction P5.

Generally, a battery management target temperature, which is a target value when the temperature of the battery 1 is adjusted by the temperature adjustment circuit 10, is lower than a drive unit management target temperature, which is a target value when the temperature of the drive unit 2 is adjusted by the temperature adjustment circuit 10.

The heat exchange circuit 12 is further provided with a fifth heat exchanger 29. The fifth heat exchanger 29 is configured by, for example, a radiator, and performs the heat exchange with the outside air of the vehicle V. As illustrated in FIG. 2, the fifth heat exchanger 29 is disposed downstream of the first heat exchanger 22 and the drive unit 2 and upstream of the second heat exchanger 24 in the flow direction B of the second refrigerant.

More specifically, in the heat exchange circuit 12, a branch point P6 is provided between the junction P5 and the fifth heat exchanger 29 described above to split the flow of the second refrigerant from the first heat exchanger 22 and the drive unit 2 into the second heat exchanger 24 side and the fifth heat exchanger 29 side. The branch point P6 is provided with a flow rate adjustment valve capable of adjusting the flow rate of the second refrigerant to the fifth heat exchanger 29 side. The flow rate adjustment valve provided at the branch point P6 adjusts the flow rate of the second refrigerant to the fifth heat exchanger 29 side, for example, under the control of the control device 4. When the flow rate of the second refrigerant to the fifth heat exchanger 29 is greater than 0, the second refrigerant is supplied to the fifth heat exchanger 29. The flow rate adjustment valve provided at the branch point P6 may also set the flow rate of the second refrigerant to the fifth heat exchanger 29 side to 0.

In the heat exchange circuit 12, a junction P7 where the flow of the second refrigerant from the junction P5 and the flow of the second refrigerant from the fifth heat exchanger 29 are joined is provided between the fifth heat exchanger 29 and the second heat exchanger 24, and the second refrigerant flows to the second heat exchanger 24 through the junction P7.

### Effects of Present Embodiment

According to the temperature adjustment circuit 10 of the present embodiment configured as described above, the first heat exchanger 22 and the second heat exchanger 24 constituting the refrigeration cycle 11 and the battery 1 as the first temperature adjustment target are disposed in this order in the heat exchange circuit 12. Therefore, when the refrigeration cycle 11 is operated while circulating the second refrigerant in the heat exchange circuit 12, the first refrigerant circulating in the refrigeration cycle 11 can be recovered via the second heat exchanger 24 before the heat transferred to the second refrigerant of the heat exchange circuit 12 via the first heat exchanger 22 is used for the temperature adjustment of the battery 1. Therefore, as compared with a case where the second heat exchanger 24 is not provided or a case where the second heat exchanger 24 is provided downstream of the battery 1 in the flow direction B of the second refrigerant, it is possible to promote the temperature increase of the first refrigerant. In particular, in a low-temperature environment, it is possible to improve the operation efficiency of the refrigeration cycle 11 by promoting the temperature increase of the first refrigerant in this manner. Further, by increasing the temperature of the first refrigerant early, it is possible to promote the temperature increase of the battery 1.

According to the temperature adjustment circuit 10 of the present embodiment, the third heat exchanger 25 is disposed upstream of the first heat exchanger 22 in the refrigeration cycle 11. Therefore, during the operation of the refrigeration cycle 11, the heat exchange can be performed by the third heat exchanger 25 before the heat exchange is performed by the first heat exchanger 22. Accordingly, the passenger compartment can be efficiently heated.

According to the temperature adjustment circuit 10 of the present embodiment, the second expansion valve 26 is disposed between the first heat exchanger 22 and the third heat exchanger 25 in the refrigeration cycle 11. Therefore, by adjusting an opening degree of the second expansion valve 26 during the operation of the refrigeration cycle 11, it is possible to adjust a heat exchange amount of the first heat exchanger 22.

According to the temperature adjustment circuit 10 of the present embodiment, the third expansion valve 27 and the fourth heat exchanger 28 are disposed downstream of the first heat exchanger 22 in the refrigeration cycle 11. Therefore, by reducing the pressure by the third expansion valve 27 during the operation of the refrigeration cycle 11, a heat exchange corresponding to heat absorption can be performed by the fourth heat exchanger 28. Accordingly, the passenger compartment can be efficiently cooled.

Further, according to the temperature adjustment circuit 10 of the present embodiment, the drive unit 2, which is the second temperature adjustment target, is disposed in parallel with the first heat exchanger 22 in the heat exchange circuit 12. Therefore, when the refrigeration cycle 11 is operated while circulating the second refrigerant in the heat exchange circuit 12, the first refrigerant circulating in the refrigeration cycle 11 can also recover, via the second heat exchanger 24, the heat obtained from the drive unit 2 by the second refrigerant circulating in the heat exchange circuit 12.

According to the temperature adjustment circuit 10 of the present embodiment, in the heat exchange circuit 12, the fifth heat exchanger 29 is disposed downstream of the first heat exchanger 22 and the drive unit 2 as the second temperature adjustment target and upstream of the second heat exchanger 24. Therefore, during the operation of the refrigeration cycle 11, the heat exchange can be performed by the fifth heat exchanger 29 before the heat exchange is performed by the second heat exchanger 24.

According to the temperature adjustment circuit 10 of the present embodiment, the cooling and heating of the battery 1 and the drive unit 2 as the drive sources of the vehicle V can be selectively performed by the operation of the heat exchange circuit 12 and the refrigeration cycle 11. By extension, it is possible to contribute to improvement of energy efficiency of the vehicle V.

Further, according to the temperature adjustment circuit 10 of the present embodiment, for example, when a quantity of electricity stored in the battery 1 is equal to or greater than a predetermined value (in other words, when it is necessary to reduce the quantity of electricity stored in the battery 1), it is possible to dissipate heat collected by the first compressor 21 or heat generated in the drive unit 2 from the fifth heat exchanger 29. At this time, the passenger compartment can be cooled by the fourth heat exchanger 28. It is also possible to heat the passenger compartment by dissipating heat from the third heat exchanger 25 without dissipating heat from the fifth heat exchanger 29. Further, it is also possible to cool the passenger compartment by the fourth heat exchanger 28 or heat the passenger compartment by the third heat exchanger 25 while dissipating the heat collected by the first compressor 21 and the heat generated by the drive unit 2 from the fifth heat exchanger 29.

Although an embodiment of the present disclosure has been described, it goes without saying that the present invention is not limited to such an example. It is apparent to those skilled in the art that various changes or modifications can be conceived within the scope described in the claims, and it is understood that the changes or modifications naturally fall within the technical scope of the present invention. In addition, constituent elements in the embodiment described above may be freely combined without departing from the gist of the present invention.

For example, in the embodiment described above, an example in which the moving object in the present invention is the vehicle V which is an electric vehicle has been described, but the present invention is not limited thereto. The present invention is also applicable to a gasoline automobile, a diesel automobile, or a hybrid electrical vehicle including an internal combustion engine (engine) as a drive source instead of or in addition to the motor M described above. The moving object in the present invention may be an electric vertical take-off and landing aircraft (eVTOL) or the like.

In the present specification, at least the following matters are described. Although corresponding constituent elements or the like in the above-described embodiments are shown in parentheses, the present invention is not limited thereto.

(1) A temperature adjustment circuit (temperature adjustment circuit 10) having:

a refrigeration cycle (refrigeration cycle 11) including:

a first compressor (first compressor 21) configured to compress and discharge a first refrigerant;

a first heat exchanger (first heat exchanger 22) configured to perform a heat exchange with the first refrigerant compressed by the first compressor;

a first expansion valve (first expansion valve 23) configured to decompress the first refrigerant that has passed through the first heat exchanger; and

a second heat exchanger (second heat exchanger 24) configured to perform a heat exchange with the first refrigerant that has passed through the first expansion valve; and

a heat exchange circuit (heat exchange circuit 12) configured to connect the first heat exchanger, the second heat exchanger, and a first temperature adjustment target (battery 1) to allow a heat exchange via the second refrigerant, in which

in the heat exchange circuit, the first heat exchanger, the second heat exchanger, and the first temperature adjustment target are, in this order, disposed in a flow direction of the second refrigerant (flow direction B of the second refrigerant).

According to (1), the first heat exchanger and the second heat exchanger constituting the refrigeration cycle and the first temperature adjustment target are disposed in this order in the heat exchange circuit. Therefore, when the refrigeration cycle is operated while circulating the second refrigerant in the heat exchange circuit, the first refrigerant circulating in the refrigeration cycle can be recovered via the second heat exchanger before the heat transferred to the second refrigerant of the heat exchange circuit via the first heat exchanger is used for the temperature adjustment of the first temperature adjustment target. Therefore, as compared with a case where the second heat exchanger is not provided or a case where the second heat exchanger is provided on the downstream side in the flow direction of the second refrigerant, it is possible to promote the temperature increase of the first refrigerant. In particular, in a low-temperature environment, it is possible to improve the operation efficiency of the refrigeration cycle by promoting the temperature increase of the first refrigerant in this manner. Further, by increasing the temperature of the first refrigerant early, it is possible to promote the temperature increase of the first temperature adjustment target.

(2) The temperature adjustment circuit according to (1), in which

the refrigeration cycle further includes a third heat exchanger (third heat exchanger 25) configured to perform a heat exchange with the first refrigerant compressed by the first compressor, and

the third heat exchanger is disposed upstream of the first heat exchanger in a flow direction of the first refrigerant (flow direction A of the first refrigerant).

According to (2), the third heat exchanger is disposed upstream of the first heat exchanger in the refrigeration cycle. Therefore, during the operation of the refrigeration cycle, the heat exchange can be performed by the third heat exchanger before the heat exchange is performed by the first heat exchanger.

(3) The temperature adjustment circuit according to (2), in which

the refrigeration cycle further includes a second expansion valve (second expansion valve 26) configured to decompress the first refrigerant that has passed through the third heat exchanger, and

the second expansion valve is disposed between the first heat exchanger and the third heat exchanger.

According to (3), the second expansion valve is disposed between the first heat exchanger and the third heat exchanger in the refrigeration cycle. Therefore, by adjusting an opening degree of the second expansion valve during the operation of the refrigeration cycle, it is possible to adjust a heat exchange amount of the first heat exchanger.

(4) The temperature adjustment circuit according to (1), in which

the refrigeration cycle further includes:

a third expansion valve (third expansion valve 27) configured to decompress the first refrigerant that has passed through the first heat exchanger; and

a fourth heat exchanger (fourth heat exchanger 28) configured to perform a heat exchange with the first refrigerant that has passed through the third expansion valve.

According to (4), the third expansion valve and the fourth heat exchanger are disposed downstream of the first heat exchanger in the refrigeration cycle. Therefore, by reducing the pressure by the third expansion valve during the operation of the refrigeration cycle, heat exchange corresponding to heat absorption can be performed by the fourth heat exchanger.

(5) The temperature adjustment circuit according to (1), in which

the heat exchange circuit further connects a second temperature adjustment target (drive unit 2) different from the first temperature adjustment target to allow the heat exchange via the second refrigerant,

the second temperature adjustment target is disposed downstream of the first temperature adjustment target and upstream of the second heat exchanger in the flow direction of the second refrigerant, and

the first heat exchanger and the second temperature adjustment target are disposed in parallel between the first temperature adjustment target and the second heat exchanger.

According to (5), the second temperature adjustment target is disposed in parallel with the first heat exchanger in the heat exchange circuit. Therefore, when the refrigeration cycle is operated while circulating the second refrigerant in the heat exchange circuit, the first refrigerant circulating in the refrigeration cycle can also recover, via the second heat exchanger, the heat obtained from the second temperature adjustment target by the second refrigerant circulating in the heat exchange circuit.

(6) The temperature adjustment circuit according to (5), in which

the heat exchange circuit further includes a fifth heat exchanger (fifth heat exchanger 29), and

the fifth heat exchanger is disposed downstream of the first heat exchanger and the second temperature adjustment target and upstream of the second heat exchanger in the flow direction of the second refrigerant.

According to (6), in the heat exchange circuit, the fifth heat exchanger is disposed downstream of the first heat exchanger and the second temperature adjustment target and upstream of the second heat exchanger. Therefore, during the operation of the refrigeration cycle, the heat exchange can be performed by the fifth heat exchanger before the heat exchange is performed by the second heat exchanger.

(7) The temperature adjustment circuit according to (5), in which

the heat exchange circuit and the refrigeration cycle are mounted on a moving object (vehicle V), and

the first temperature adjustment target and the second temperature adjustment target are drive sources (battery 1, drive unit 2) of the moving object.

According to (7), cooling and heating of the drive source of the moving object can be selectively performed by the operation of the heat exchange circuit and the refrigeration cycle.

What is claimed is:

1. A temperature adjustment circuit comprising:
a refrigeration cycle including:
a first compressor configured to compress and discharge a first refrigerant;
a first heat exchanger configured to perform a heat exchange with the first refrigerant compressed by the first compressor;
a first expansion valve configured to decompress the first refrigerant that has passed through the first heat exchanger; and
a second heat exchanger configured to perform a heat exchange with the first refrigerant that has passed through the first expansion valve; and
a heat exchange circuit configured to connect the first heat exchanger, the second heat exchanger, and a first temperature adjustment target to allow a heat exchange via the second refrigerant, wherein
in the heat exchange circuit, the first heat exchanger, the second heat exchanger, and the first temperature adjustment target are, in this order, disposed in a flow direction of the second refrigerant.

2. The temperature adjustment circuit according to claim 1, wherein
the refrigeration cycle further includes a third heat exchanger configured to perform a heat exchange with the first refrigerant compressed by the first compressor, and
the third heat exchanger is disposed upstream of the first heat exchanger in a flow direction of the first refrigerant.

3. The temperature adjustment circuit according to claim 2, wherein
the refrigeration cycle further includes a second expansion valve configured to decompress the first refrigerant that has passed through the third heat exchanger, and
the second expansion valve is disposed between the first heat exchanger and the third heat exchanger.

4. The temperature adjustment circuit according to claim 1, wherein
the refrigeration cycle further includes:
a third expansion valve configured to decompress the first refrigerant that has passed through the first heat exchanger; and
a fourth heat exchanger configured to perform a heat exchange with the first refrigerant that has passed through the third expansion valve.

5. The temperature adjustment circuit according to claim 1, wherein
the heat exchange circuit further connects a second temperature adjustment target different from the first temperature adjustment target to allow the heat exchange via the second refrigerant,
the second temperature adjustment target is disposed downstream of the first temperature adjustment target and upstream of the second heat exchanger in the flow direction of the second refrigerant, and
the first heat exchanger and the second temperature adjustment target are disposed in parallel between the first temperature adjustment target and the second heat exchanger.

6. The temperature adjustment circuit according to claim 5, wherein
the heat exchange circuit further includes a fifth heat exchanger, and
the fifth heat exchanger is disposed downstream of the first heat exchanger and the second temperature adjustment target and upstream of the second heat exchanger in the flow direction of the second refrigerant.

7. The temperature adjustment circuit according to claim 5, wherein
the heat exchange circuit and the refrigeration cycle are mounted on a moving object, and
the first temperature adjustment target and the second temperature adjustment target are drive sources of the moving object.
